(19) United States
(12) Patent Application Publication
(10) Pub. No.: US 2015/0016273 A1
(43) Pub. Date: Jan. 15, 2015

(54) MONITORING APPARATUS AND METHOD

(71) Applicant: KABUSHIKI KAISHA TOSHIBA, Tokyo (JP)

(72) Inventors: Tatsuma HIRANO, Tokyo (JP); Cam Ly NGUYEN, Yokohama-shi (JP); Toshiyuki NAKANISHI, Yokohama-shi (JP); Ren SAKATA, Yokohama-shi (JP)

(21) Appl. No.: 14/326,044

(22) Filed: Jul. 8, 2014

(30) Foreign Application Priority Data
Jul. 10, 2013 (JP) 2013-144553

(51) Int. Cl. H04L 12/26

(52) U.S. Cl. CPC H04L 43/08
USPC 370/241

(57) ABSTRACT

According to one embodiment, a monitoring apparatus includes a communication unit and a determination unit. The communication unit is configured to calculate a first indicator value and a second indicator value, the first indicator value relating to a received signal strength at a time when a packet transmitted from a first wireless device is received, the second indicator value relating to a received signal strength at a time when carrier sense is executed. The determination unit is configured to determine a state of the first wireless device to be one of three or more states, by performing a state determination using the first indicator value and the second indicator value, with a current state of the first wireless device being set as a basic point.

### CROSS-REFERENCE TO RELATED APPLICATIONS

This application is based upon and claims the benefit of priority from Japanese Patent Application No. 2013-144553, filed Jul. 10, 2013, the entire contents of which are incorporated herein by reference.

### FIELD

Embodiments described herein relate generally to a monitoring apparatus and method.

### BACKGROUND

In applying wireless devices to a social-infrastructure system, there is a demand for a function for keeping track of the states of the wireless devices and clearly monitoring a cause when abnormality has occurred in the wireless devices. Since it is assumed that the wireless devices, which are applied to the social-infrastructure system, are wireless devices of various standards depending on purposes of use, it is desirable to use techniques which are free of restrictions to the standards of wireless devices. This being the case, there is known an abnormality detection technique in which a received signal strength indicator (RSSI) at a time of communication of a wireless device, which is not restricted by standards, is used as information for monitoring the wireless device. For example, there is a technique in which a radio frequency identification (RFID) is attached to a target of monitoring, and an RSSI at a normal time is measured in advance by using an RSSI of a wireless signal which is transmitted from the RFID, thereby executing determination between a normal state of the target of monitoring and a different state. In addition, as a method in which measurement is not executed in advance, there is known a technique which makes use of such a characteristic that the ratio between RSSIs of two wireless devices becomes substantially constant at a normal state. In this technique, if an obstruction exists in the vicinity of a wireless device, shutoff, absorption, reflection or scattering occurs with respect to the wireless signal which is received by this wireless device, and the ratio in RSSI varies. Thus, by detecting this variation, the obstruction is detected.

### BRIEF DESCRIPTION OF THE DRAWINGS

FIG. 1 is a conceptual view illustrating a wireless communication system.

FIG. 2 is a block diagram illustrating a monitoring apparatus according to a first embodiment.

FIG. 3 is a view illustrating a state transition of a wireless device.

FIG. 4 is a flowchart illustrating a determination process of the monitoring apparatus according to the first embodiment.

FIG. 5 is a flowchart illustrating a determination process in a case where there are a plurality of channels.

FIG. 6 is a flowchart illustrating a determination process in a case where a current state is “moving”.

FIG. 7 is a flowchart illustrating a determination process in a case where the current state is “jamming”.

FIG. 8 is a flowchart illustrating a determination process in a case where the current state is “fault”.

FIG. 9 is a flowchart illustrating a determination process in a case where the current state is “out-of-range”.

FIG. 10 is a flowchart illustrating a determination process of a monitoring apparatus according to a second embodiment.

FIG. 11 is a block diagram illustrating a monitoring apparatus according to a fourth embodiment.

FIG. 12 is a block diagram illustrating a monitoring apparatus according to a fifth embodiment.

### DETAILED DESCRIPTION

In the above-described techniques using the RSSI, in order to detect a plurality of states, measurement is needed in advance. In addition, when advance measurement is not executed, as in the case of a moving object detection apparatus, only two states, i.e. the presence and absence of a jamming, can be determined.

In general, according to one embodiment, a monitoring apparatus includes a communication unit and a determination unit. The communication unit is configured to calculate a first indicator value and a second indicator value, the first indicator value relating to a received signal strength at a time when a packet transmitted from a first wireless device is received, the second indicator value relating to a received signal strength at a time when carrier sense is executed. The determination unit is configured to determine a state of the first wireless device to be one of three or more states, by performing a state determination using the first indicator value and the second indicator value, with a current state of the first wireless device being set as a basic point.

In the following, the monitoring apparatus and method according to an embodiment of the present disclosure will be explained with reference to the drawings. In the following embodiments, the explanation of the elements with the same reference numerals will be omitted for brevity as their operations will be the same.

### First Embodiment

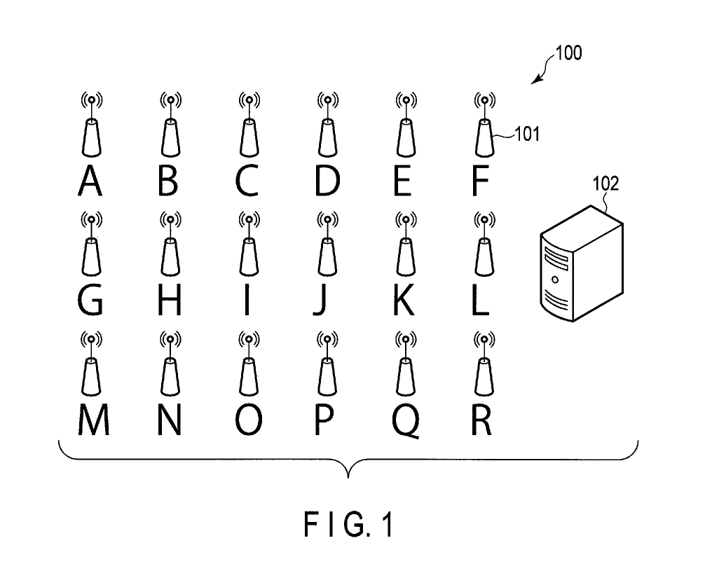

A conceptual view of a wireless communication system including a monitoring apparatus according to a first embodiment will be explained with reference to FIG. 1.

A wireless communication system 100 according to the first embodiment includes a plurality of wireless devices 101 and a monitoring apparatus 102.

Each of the wireless devices 101 is connected to sensors (not shown) such as a temperature sensor, a pressure sensor and an acceleration sensor, and transmits sensor information, which is a value obtained from the sensors, to the monitoring apparatus 102 as packets. Although an example, in which 18 wireless devices 101, namely a wireless device A to a wireless device R, are present, is illustrated, the number of wireless devices 101 may be an arbitrary number. In addition, the wireless devices 101 may transmit sensor information to one another. Although it is assumed that the standard, which is used for wireless communication between the wireless devices 101 and the monitoring apparatus 102, is, for instance, ZigBee®, Bluetooth® or Wi-Fi®, any standard may be used if communication between the wireless devices 101 and monitoring apparatus 102 is enabled.

The monitoring apparatus 102 receives a packet including sensor information transmitted from the wireless device 101, and measures and stores an indicator value that is a value relating to received signal strength (RSS) at a time when the packet has been received. Based on the indicator value, the monitoring apparatus 102 determines the state of the wireless device 101 to be one of three or more states, with the current state of the wireless device 101 being set as a basic point. Although the received signal strength indicator (RSSI) is described as an example of the indicator value in the present embodiment, a difference value between an RSSI, which has been measured when a packet has been received, and an RSSI, which is measured with respect to a packet which was received immediately before, may be used as the indicator value. A level value, which is obtained by classifying the value of the RSSI into some levels, may be used as the indicator value.

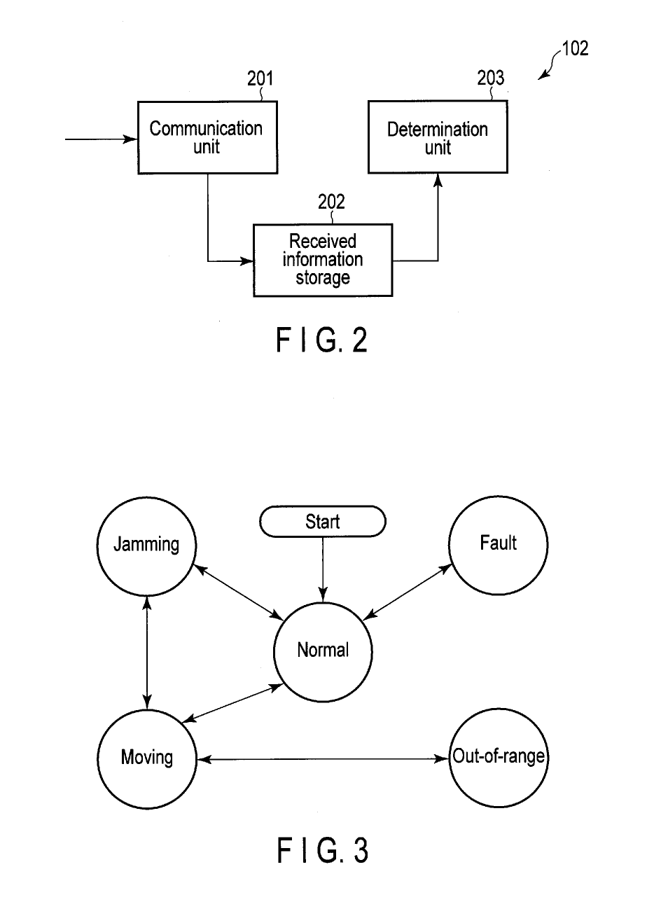

A block diagram of the monitoring apparatus 102 will be explained with reference to FIG. 2.

The monitoring apparatus 102 includes a communication unit 201, a received information storage 202 and a determination unit 203.

The communication unit 201 receives from the wireless device 101 a frame including sensor information and transmission source information indicative of the ID of the wireless device 101, and measures an RSSI at a time when the frame has been received.

The received information storage 202 receives the sensor information, transmission source information and the RSSI from the communication unit 201, and stores them.

The determination unit 203 receives the transmission source information and RSSI from the received information storage 202, and determines the state of the wireless device 101, based on the transmission source information and the RSSI.

A state of the wireless device 101 which is determined by the determination unit 203 will be explained with reference to FIG. 3.

FIG. 3 shows a state transition diagram relating to the wireless device 101. Based on this state transition diagram, the state of each wireless device 101 is determined. In the present embodiment, as the states of the wireless device 101, the following states are assumed: “normal” that is a state in which the wireless device 101 is normally operating; “moving” that is a state in which the wireless device 101 is moving; “fault” that is a state in which the wireless device 101 is faulty; “jamming” that is a state in which a wireless device of another wireless communication system exists near the wireless device 101, and jamming occurs in the communication in the wireless communication system 100; and “out-of-range” that is a state in which the wireless device 101 exists at a location where wireless communication is disabled, that is, a state in which the wireless device 101 is out of the coverage area.

In the meantime, when “normal” transitions to “out-of-range”, it is considered that the state of the wireless device 101 transitions through the “moving” state unless the wireless device 101 is faulty. Thus, the state of the wireless device 101 is not transitioned directly from “normal” to “out-of-range”.

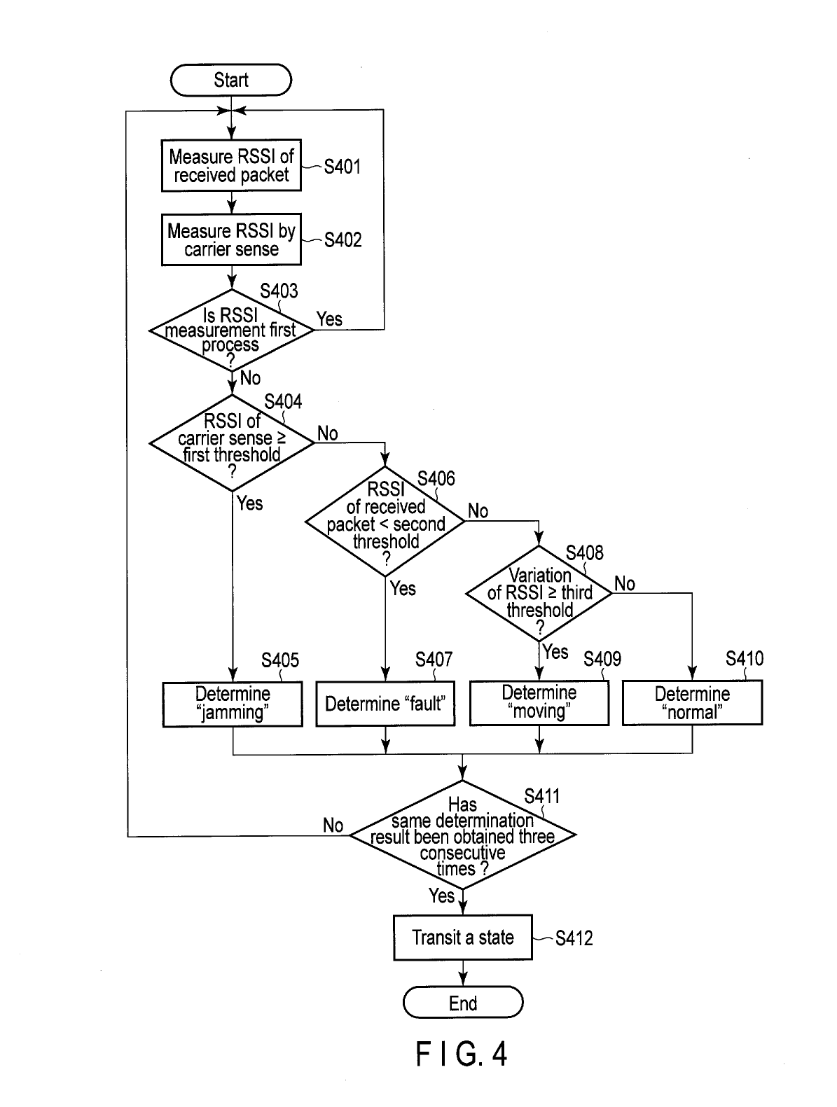

The determination process of the monitoring apparatus 102 will be explained with reference to a flowchart of FIG. 4. It is assumed that the initial state of the wireless device 101 is “normal”, the monitoring apparatus 102 does not move, and there is no fault in the communication function of the monitoring apparatus 102.

In step S401, the communication unit 201 receives a packet from the wireless device 101, acquires the information of the packet (hereinafter, also referred to as “received packet”), and measures the RSSI at a time when the packet has been received.

In step S402, the communication unit 201 executes carrier sense of the wireless channel.

In step S403, the determination unit 203 determines whether or not the acquisition of the RSSI of the received packet in step S401 and the carrier sense in step S402 are the first process. If the acquisition of the RSSI of the received packet and the carrier sense are the first process, the process returns to step S401 and the same process is repeated. If the acquisition of the RSSI of the received packet and the carrier sense are not the first process, that is, a second or subsequent process, the process proceeds to step S404.

In step S404, the determination unit 203 determines whether or not the value of the RSSI obtained by the carrier sense is not less than a first threshold value. If the value of the RSSI obtained by the carrier sense is not less than the first threshold value, the process proceeds to step S405. If the value of the RSSI obtained by the carrier sense is less than the first threshold value, the process proceeds to step S406.

In step S405, since it is considered that a jamming exists in the communication between the monitoring apparatus 102 and the wireless device 101, the determination unit 203 determines that the state of the wireless device 101 is “jamming”.

In step S406, the determination unit 203 determines whether or not the RSSI of the received packet is less than a second threshold value. If the RSSI of the received packet is less than the second threshold value, the process proceeds to step S407. If the RSSI of the received packet is not less than the second threshold value, the process proceeds to step S408.

In step S407, since it is considered that the packet from the wireless device 101 has failed to be received, the determination unit 203 determines that the state of the wireless device 101 is “fault”.

In step S408, the determination unit 203 determines whether or not an absolute value of a difference value between the RSSI of the latest received packet and the RSSI of the second latest received packet, which was received immediately before, that is, a variation of the RSSI of the received packet, is not less than a third threshold value. If this variation of the RSSI is not less than the third threshold value, the process proceeds to step S409. If the variation of the RSSI is less than the third threshold value, the process proceeds to step S410.

In step S409, since it is considered that the variation of the RSSI of the received packet is due to a variation in distance between the wireless device 101 and the monitoring apparatus 102, the determination unit 203 determines that the state of the wireless device 101 is “moving”.

In step S410, since it is considered that no jamming exists in the communication with the wireless device 101, the packet from the wireless device 101 has been normally received and the wireless device 101 is not moving, the determination unit 203 determines that the state of the wireless device 101 is “normal”.

In step S411, the determination unit 203 determines whether or not the same determination result obtains three consecutive times. If the same determination result is obtained three consecutive times, the process goes to step S412. If the same determination result is not obtained three consecutive times, the process returns to step S401, and the same process is repeated.

In step S412, the state of the wireless device 101 is transitioned from “normal” to the state of the determination result which has been determined three consecutive times. Thus, the process of the monitoring apparatus is finished.

In the present embodiment, in order to reduce the RSSI variation due to fading, the state transition is effected only when the same determination result is obtained three consecutive times, as illustrated in step S411. However, this embodiment is not limited to this example. The process of step S411 may be omitted, and the state transition may be effected each time the determination is executed. In addition, instead of step S411, the state transition may be effected when, among a natural number M (M≧2) of determination results, the same determination result is obtained a natural number N of times (M≧N). In the present embodiment, although the determination is executed by using instantaneous values of the RSSI, various averaging methods may be used in order to take into account the variation of the RSSI due to fading.

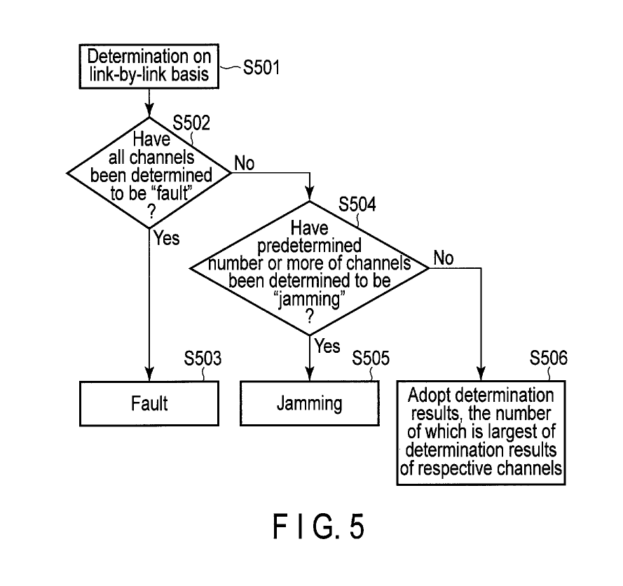

In the flowchart shown in FIG. 4, the case is assumed in which the number of frequency channels that are used by the wireless device 101 for communication is one. However, when the frequency channel used for communication ranges over a plurality of frequency channels, the determination may be executed with respect to each of the channels. The case of executing the determination on a channel-by-channel basis will be explained with reference to a flowchart of FIG. 5.

In step S501, the determination unit 203 obtains a determination result of the state with respect to each channel.

In step S502, the determination unit 203 determines whether or not the determination results of all channels are “fault”. If the determination results of all channels are “fault”, the process proceeds to step S503. If the determination results of all channels are not “fault”, the process proceeds to step S504.

In step S503, the state transition is executed by setting the states of all channels to be “fault”.

In step S504, it is determined whether or not the number of channels, which have been determined to be “jamming”, is not less than a predetermined number. If the number of channels is not less than the predetermined number, the process proceeds to step S505. If the number of channels is less than the predetermined number, the process proceeds to step S506.

In step S505, the state transition is executed by setting the states of all channels to be “jamming”.

In step S506, the state transition is executed by setting the determination results, the number of which is largest of the determination results of the respective channels, to be the state of all channels. The determination on a channel-by-channel basis is thus finished. Thereby, the same advantageous effect as in the case of averaging the variation of the RSSI can be obtained.

A description is given of a concrete example of the state transition relating to the wireless device 101 in a case where the current state, as the initial state, is “normal”. In the description below, by way of example, the first threshold value in the determination process illustrated in FIG. 4 is set at −50 [dBm], the second threshold value is set at −92 [dBm] and the third threshold value is set at 3 [dB].

(1) State Transition from “Normal” to “Moving”

As a general monitoring system, the case is assumed in which the wireless device 101 periodically sends sensor information to the monitoring apparatus 102. Thus, the case is now assumed in which a wireless access method between the wireless device 101 and monitoring apparatus 102 is time division multiple access (TDMA). The monitoring apparatus 102 receives packets including sensor information from the wireless device 101 at frame time intervals of TDMA.

The RSSI of the received packet obtained in the process of step S401, it is assumed that the RSSI of the received packet at a time point (time instant T1) at which the first received packet is obtained is −65 [dBm], and the RSSI of the received packet at a time point (time instant T2) (T2>T1+τ:τ is 1 TDMA frame time) at which the second received packet is obtained is −60 [dBm]. In addition, the RSSI of the carrier sense obtained in the process of step S402, it is assumed that the RSSI by the carrier sense at time instant T1 is −92 [dBm], and the RSSI by the carrier sense at time instant T2 is −93 [dBm].

In this case, the state determination process at time instant T2 is executed according to the flowchart of FIG. 4. In the determination of step S404, since the RSSI of the carrier sense result is −93 [dBm] and is less than −50 [dBm] that is the first threshold value, the process proceeds to step S406. Next, since the RSSI of the received packet is −60 [dBm] and is greater than −92 [dBm] that is the second threshold value, the process proceeds to step S408. Subsequently, since the variation of the RSSI of the received packet from time instant T1 to time instant T2 is 5 [dB] that is the absolute value of the difference between −65 [dBm] and −60 [dBm], and is not less than 3 [dB] that is the third threshold value, a determination result that the state is “moving” is obtained.

Next, the case is assumed in which the RSSI of the received packet, which is received at time instant T3 later than time instant T2 (T3>T2+τ), is −50 [dBm], and the RSSI of the carrier sense result is −92 [dBm].

Like the above, in step S404, since the RSSI of the carrier sense result is −92 [dBm] and is less than −50 [dBm] that is the first threshold value, the process proceeds to step S406. Next, since the RSSI of the received packet is −50 [dBm] and is greater than −92 [dBm] that is the second threshold value, the process proceeds to step S408. Subsequently, since the variation of the RSSI of the received packet from time instant T2 to time instant T3 is 10 [dB] that is the absolute value of the difference between −60 [dBm] and −50 [dBm], and is not less than 3 [dB] that is the third threshold value, a determination result that the state is “moving” is obtained.

Next, the case is assumed in which the RSSI of the received packet, which is received at time instant T4 later than time instant T3 (T4>T3+τ), is −32 [dBm], and the RSSI of the carrier sense result is −92 [dBm].

Like the above, in step S404, since the RSSI of the carrier sense result is −92 [dBm] and is less than −50 [dBm] that is the first threshold value, the process proceeds to step S406. Next, since the RSSI of the received packet is −32 [dBm] and is greater than −92 [dBm] that is the second threshold value, the process proceeds to step S408. Subsequently, since the variation of the RSSI of the received packet from time instant T3 to time instant T4 is 18 [dB] that is the absolute value of the difference between −50 [dBm] and −32 [dBm], and is not less than 3 [dB] that is the third threshold value, a determination result that the state is “moving” is obtained.

In this case, since “moving” has been determined three consecutive times, the state of the wireless device 101 is transitioned from “normal” to “moving”, according to the state transition diagram illustrated in FIG. 3. In the meantime, such more specific determination may be executed that the wireless device 101 is moving in a direction in which the distance between the wireless device 101 and the monitoring apparatus 102 increases in the case where the RSSI of the received packet decreases with the passing of time, and, conversely, the wireless device 101 is moving in a direction in which the distance between the wireless device 101 and the monitoring apparatus 102 decreases in the case where the RSSI of the received packet increases with the passing of time.

In the present embodiment, although the case in which the wireless access method is TDMA has been described by way of example, this embodiment is applicable not only to the case of TDMA, but also to various wireless methods such as Carrier Sense Multiple Access with Collision Avoidance (CSMA/CA).

(2) State Transition from “Normal” to “Jamming”

Like the above, it is assumed that the RSSI of the first received packet obtained in the process of step S401 at time instant T1 is −65 [dBm], and the RSSI of the carrier sense obtained in the process of step S402 is −48 [dBm].

According to the flowchart of FIG. 4, in step S404, since the RSSI of the carrier sense result at time instant T1 is −48 [dBm] and is not less than the first threshold value, it is determined that the state is “jamming”.

Next, at time instant T2, it is assumed that −50 [dBm] is obtained as the RSSI of the received packet, and −42 [dBm] is obtained as the RSSI of the carrier sense result. In this case, too, in step S404, since −42 [dBm], which is the RSSI of the carrier sense result, is not less than the first threshold value, it is determined that the state is “jamming”.

Next, at time instant T3, it is assumed that −62 [dBm] is obtained as the RSSI of the received packet, and −45 [dBm] is obtained as the RSSI of the carrier sense result. In step S404, since −45 [dBm], which is the RSSI of the carrier sense result, is not less than the first threshold value, it is determined that the state is “jamming”.

In this case, since “jamming” has been determined three consecutive times, the state of the wireless device 101 is transitioned from “normal” to “jamming”, according to the state transition diagram illustrated in FIG. 3.

(3) State Transition from “Normal” to “Fault”

At time instant T1, it is assumed that the RSSI of the received packet is −65 [dBm], and the RSSI of the carrier sense result is −92 [dBm].

Next, at time instant T2, it is assumed that the RSSI of the carrier sense result is −92 [dBm]. The case is supposed in which no packet can be received at time instant T2. In this case, in order to determine that the reception is not possible, the RSSI of the received packet is set at −120 [dBm] so that the RSSI is not more than a limit value of receiving.

In this case, the state determination process is executed according to the flowchart of FIG. 4. In step S404, since −92 [dBm] of the RSSI of the carrier sense result is less than the first threshold value, the process proceeds to step S406. Next, since the RSSI of the received packet is −120 [dBm] and is less than the second threshold value, it is determined that the state is “fault”.

Subsequently, at time instant T3, it is assumed that the RSSI of the carrier sense result is −93 [dBm]. At time instant T3, like time instant T2, the case is assumed in which no packet can be received, and the RSSI of the received packet is set at −120 [dBm].

In the determination at time instant T3, in step S404, since −93 [dBm] of the RSSI of the carrier sense result is less than the first threshold value, the process proceeds to step S406. Next, since the RSSI of the received packet is −120 [dBm] and is less than the second threshold value, it is determined that the state is “fault”.

Following the above, at time instant T4, it is assumed that the RSSI of the carrier sense result is −91 [dBm]. At time instant T4, too, the case is assumed in which no packet can be received, and the RSSI of the received packet is set at −120 [dBm].

In the determination at time instant T4, in step S404, since −91 [dBm] of the RSSI of the carrier sense result is less than the first threshold value, the process proceeds to step S406. Next, since the RSSI of the received packet is −120 [dBm] and is less than the second threshold value, it is determined that the state is “fault”.

In this case, since “fault” has been determined three consecutive times, the state of the wireless device 101 is transitioned from “normal” to “fault”, according to the state transition diagram illustrated in FIG. 3.

(4) Case in which the State Remains “Normal”

It is assumed that the RSSI of the first received packet, which is obtained in the process of step S401 at time instant T1, is −65 [dBm], and the RSSI of the received packet obtained at time instant T2 is −60 [dBm]. In addition, the RSSI of the carrier sense obtained in the process of step S402, it is assumed that the RSSI by the carrier sense at time instant T1 is −92 [dBm], and the RSSI by the carrier sense at time instant T2 is −93 [dBm].

In this case, the determination at time instant T2, in the determination of step S404, since the RSSI of the carrier sense result is −93 [dBm] and is less the first threshold value, the process proceeds to step S406. Next, since the RSSI of the received packet is −60 [dBm] and is greater than the second threshold value, the process proceeds to step S408. Subsequently, in step S408, since the variation of the RSSI of the received packet is 5 [dB] that is the absolute value of the difference between −65 [dBm] and −60 [dBm], and is not less than the third threshold value, a determination result that the state is “moving” is obtained.

Next, at time instant T3, it is assumed that the RSSI of the received packet is −60 [dBm], and the RSSI of the carrier sense result is −90 [dBm].

Like the above, in step S404, since the RSSI of the carrier sense result is −90 [dBm] and is less than the first threshold value, the process proceeds to step S406. Next, since the RSSI of the received packet is −60 [dBm] and is greater than the second threshold value, the process proceeds to step S408. Subsequently, since the variation of the RSSI of the received packet from time instant T2 is 0 [dB] that is the absolute value of the difference between −60 [dBm] and −60 [dBm], and is less than the third threshold value, a determination result that the state is “normal” is obtained.

Next, at time instant T4, it is assumed that the RSSI of the received packet is −67 [dBm], and the RSSI of the carrier sense result is −94 [dBm].

In step S404, since the RSSI of the carrier sense result is −94 [dBm] and is less than the first threshold value, the process proceeds to step S406. Next, since the RSSI of the received packet is −67 [dBm] and is greater than −92 [dBm] that is the second threshold value, the process proceeds to step S408. Subsequently, since the variation of the RSSI of the received packet is 7 [dB] that is the absolute value of the difference between −60 [dBm] and −67 [dBm], and is not less than the third threshold value, a determination result that the state is “moving” is obtained.

At time instant T4, since the same determination result has not been obtained three consecutive times, no transition occurs from the state of “normal” to another state.

### First Modification of the First Embodiment

In the above-described first embodiment, the determination of the state transition in the case where the current state that is the basic point of the wireless device 101 is “normal” is described. In a first modification of the first embodiment, a description is given of the determination of the state transition in the case where the current state that is the basic point of the wireless device 101 is “moving”. The network configuration and the information stored at a time of wireless communication in the first modification, the first modification is the same as the first embodiment.

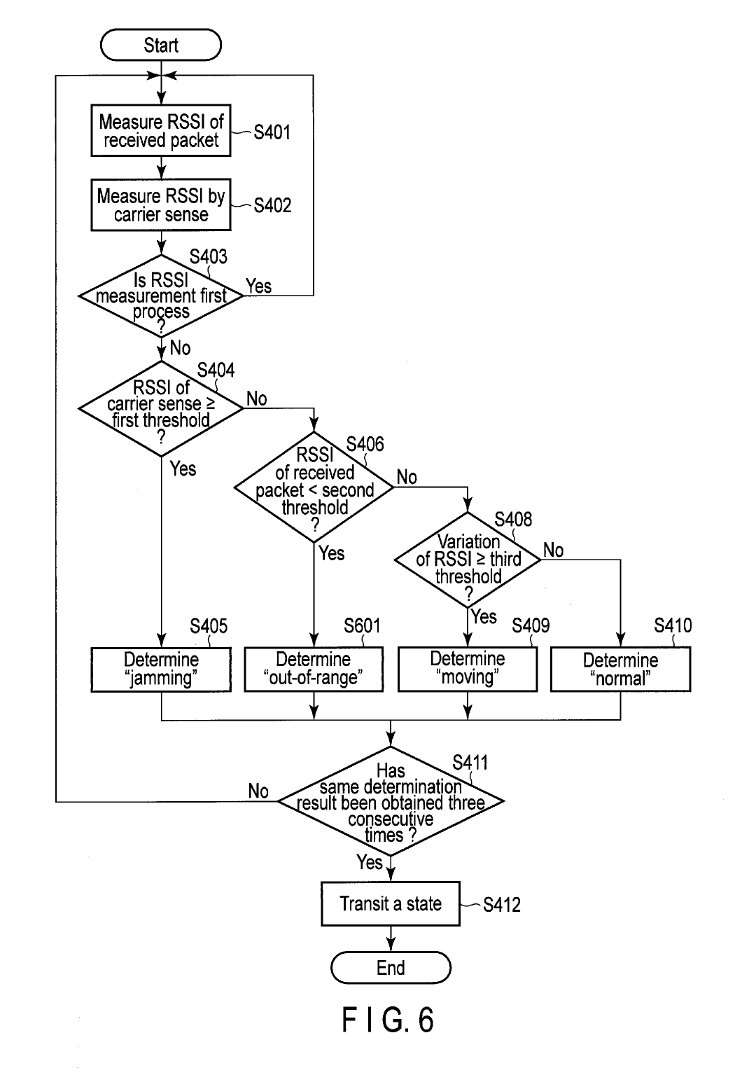

Referring now to a flowchart of FIG. 6, the determination process of the monitoring apparatus 102 in the case where the current state of the wireless device 101 is “moving” is described by illustrating a concrete example. Since the steps excluding step S601 are the same as steps S401 to S406 and steps S408 to S412 in FIG. 4, a description thereof is omitted here.

In step S601, the determination unit 203 determines the state of the wireless device 101 to be “out-of-range”, if the RSSI of the received packet is less than the second threshold value.

A description is given of the state transition from “moving” to “out-of-range”. In the meantime, since the state transition from “moving” to “jamming”, the case in which the state remains “moving”, and the state transition from “moving” to “normal” are the same as in the first embodiment, a description thereof is omitted here.

At time instant T1, it is assumed that the RSSI of the received packet is −65 [dBm], and the RSSI of the carrier sense result is −92 [dBm].

Next, at time instant T2, it is assumed that the RSSI of the carrier sense result is −93 [dBm]. Supposing the case in which no packet can be received at time instant T2, the RSSI of the received packet is set at −120 [dBm].

In this case, the state determination at time instant T2 is executed according to the flowchart of FIG. 6. In step S404, since −92 [dBm] of the RSSI of the carrier sense result is less than the first threshold value, the process proceeds to step S406. Next, since the RSSI of the received packet is −120 [dBm] and is less than the second threshold value, it is determined that the state is “out-of-range”.

Subsequently, at time instant T3, it is assumed that the RSSI of the carrier sense is −92 [dBm]. At time instant T3, too, the case is assumed in which no packet can be received, and the RSSI of the received packet is set at −120 [dBm].

In step S404, since −92 [dBm] of the RSSI of the carrier sense result is less than the first threshold value, the process proceeds to step S406. Next, since the RSSI of the received packet is −120 [dBm] and is less than the second threshold value, it is determined that the state is “out-of-range”.

Following the above, at time instant T4, it is assumed that the RSSI of the carrier sense result is −91 [dBm]. At time instant T4, too, the case is assumed in which no packet can be received, and the RSSI of the received packet is set at −120 [dBm].

In step S404, since −91 [dBm] of the RSSI of the carrier sense result is less than the first threshold value, the process proceeds to step S406. Next, since the RSSI of the received packet is −120 [dBm] and is less than the second threshold value, it is determined that the state is “out-of-range”.

In this case, since “out-of-range” has been determined three consecutive times, the state of the wireless device 101 is transitioned from “moving” to “out-of-range”, according to the state transition diagram illustrated in FIG. 3.

### Second Modification of the First Embodiment

In a second modification of the first embodiment, a description is given of the determination of the state transition in the case where the current state that is the basic point of the wireless device 101 is “jamming”. The network configuration and the information stored at a time of wireless communication in the second modification, the second modification is the same as the first embodiment.

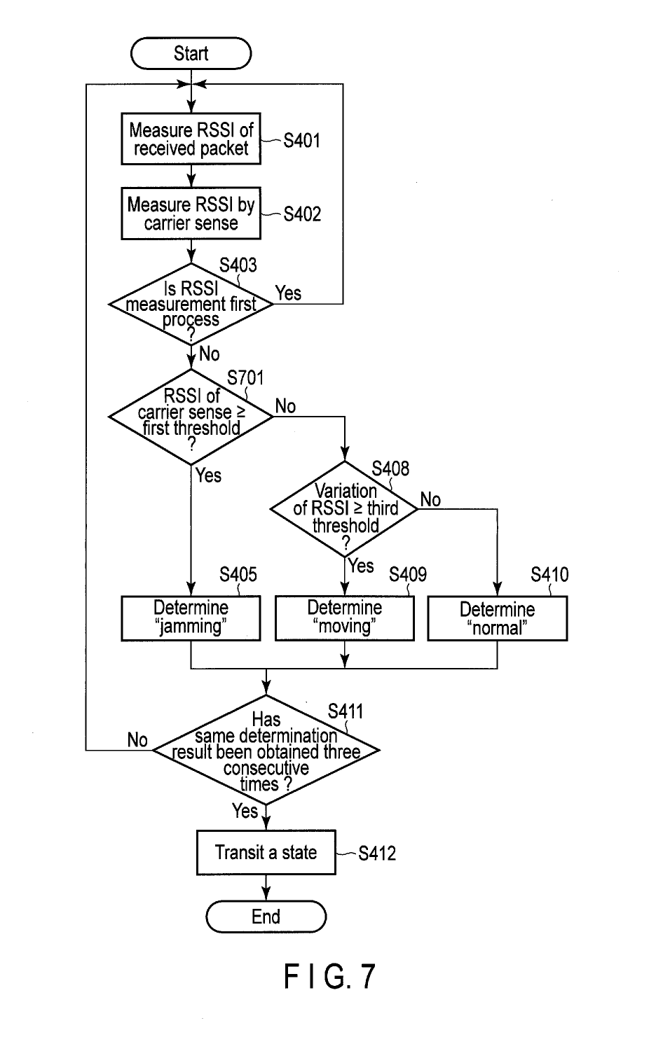

Referring now to a flowchart of FIG. 7, the determination process of the monitoring apparatus 102 in the case where the current state of the wireless device 101 is “jamming” is described by illustrating a concrete example. Incidentally, since the steps excluding step S701 are the same as steps S401 to S403, step S405, and steps S408 to S412 in FIG. 4, a description thereof is omitted here. In addition, since the transition in which the state remains “jamming” is the same as the state transition from “normal” to “jamming”, a description thereof is omitted.

In step S701, the determination unit 203 determines whether or not the value of the RSSI of the carrier sense is not less than the first threshold value. If the value of the RSSI is not less than the first threshold value, the process proceeds to step S405. If the value of the RSSI obtained by the carrier sense is not less than the first threshold value, the process proceeds to step S408.

When the state of the wireless device 101 is “jamming”, it is considered that normal communication cannot be executed in many cases, and packet loss occurs frequently. Accordingly, if packet loss occurs, the state of the wireless device 101 tends to be determined to be “fault”. Thus, the state transition from “jamming” to “fault” is not executed, so that the present state may not erroneously be determined to be “fault” when the present state is “jamming”.

(1) State Transition from “Jamming” to “Moving”

At time instant T1, it is assumed that the RSSI of the received packet, which is obtained in the process of step S401, is −65 [dBm], and the RSSI of the received packet obtained at time instant T2 is −60 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 7, in step S701, since the RSSI of the carrier sense result is −93 [dBm] and is less the first threshold value, the process proceeds to step S408. Subsequently, since the variation of the RSSI of the received packet is 5 [dB] that is the absolute value of the difference between −65 [dBm] and −60 [dBm], and is not less than the third threshold value, a determination result that the state is “moving” is obtained.

Next, at time instant T3, it is assumed that the RSSI of the received packet is −50 [dBm], and the RSSI of the carrier sense result is −92 [dBm].

At time instant T3, in step S701, since −92 [dBm], which is the RSSI of the carrier sense result, is less than the first threshold value, the process goes to step S408. Next, since the variation of the RSSI of the received packet is 10 [dB] that is the absolute value of the difference between −60 [dBm] and −50 [dBm], and is not less than the third threshold value, a determination result that the state is “moving” is obtained.

Subsequently, at time instant T4, it is assumed that the RSSI of the received packet is −32 [dBm], and the RSSI of the carrier sense result is −92 [dBm].

At time instant T4, in step S701, since −92 [dBm] of the RSSI of the carrier sense result is less than the first threshold value, the process proceeds to step S408. Next, since the variation of the RSSI of the received packet is 18 [dB] that is the absolute value of the difference between −50 [dBm] and −32 [dBm], and is not less than the third threshold value, a determination result that the state is “moving” is obtained.

In this case, since “moving” has been determined three consecutive times, the state of the wireless device 101 is transitioned from “jamming” to “moving”, according to the state transition diagram illustrated in FIG. 3.

(2) State Transition from “Jamming” to “Normal”

At time instant T1, it is assumed that the RSSI of the received packet, which is obtained in the process of step S401, is −65 [dBm], and the RSSI of the received packet obtained at time instant T2 is −66 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 7, in step S701, since the RSSI of the carrier sense result is −93 [dBm] and is less the first threshold value, the process proceeds to step S408. Subsequently, since the variation of the RSSI of the received packet is 1 [dB] that is the absolute value of the difference between −65 [dBm] and −66 [dBm], and is less than the third threshold value, the process proceeds to step S410 and a determination result that the state is “normal” is obtained.

Next, at time instant T3, it is assumed that the RSSI of the received packet is −64 [dBm], and the RSSI of the carrier sense result is −92 [dBm].

As above, in step S701, since −92 [dBm], which is the RSSI of the carrier sense result, is less than the first threshold value, the process goes to step S408. Next, since the variation of the RSSI of the received packet is 2 [dB] that is the absolute value of the difference between −66 [dBm] and −64 [dBm], and is less than the third threshold value, a determination result that the state is “normal” is obtained.

Subsequently, at time instant T4, it is assumed that the RSSI of the received packet is −64 [dBm], and the RSSI of the carrier sense result is −91 [dBm].

As above, in step S701, since −91 [dBm], which is the RSSI of the carrier sense result, is less than the first threshold value, the process goes to step S408. Next, since the variation of the RSSI of the received packet is 0 [dB] that is the absolute value of the difference between −64 [dBm] and −64 [dBm], and is less than the third threshold value, a determination result that the state is “normal” is obtained.

At time instant T4, since the same determination result has been obtained three consecutive times, the state of the wireless device 101 is transitioned from “jamming” to “normal”, according to the state transition diagram illustrated in FIG. 3.

### Third Modification of the First Embodiment

In a third modification of the first embodiment, a description is given of the determination of the state transition in the case where the state of the wireless device 101 is “fault”. The network configuration and the information stored at a time of wireless communication in the third modification, the third modification is the same as the first embodiment.

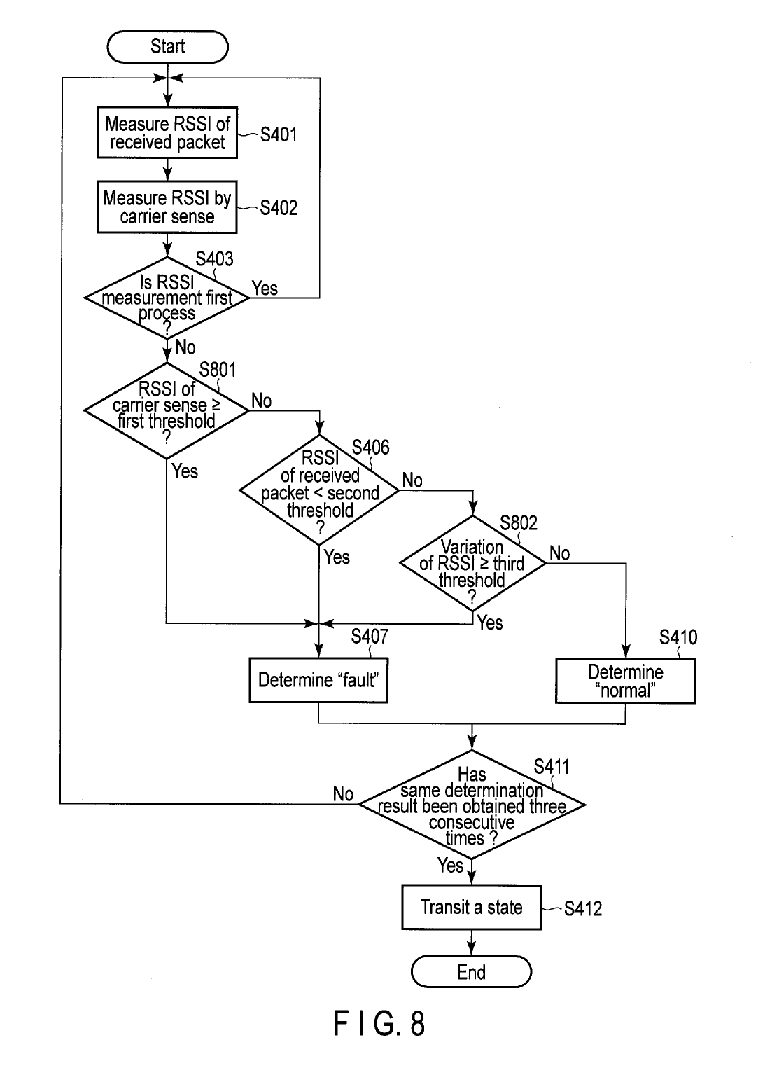

Referring now to a flowchart of FIG. 8, the determination process of the monitoring apparatus 102 in the case where the current state of the wireless device 101 is “fault” is described by illustrating a concrete example. Incidentally, since the steps excluding steps S801 and S802 are the same as steps S401 to S403, step S406, step S407, and steps S410 to S412 in FIG. 4, a description thereof is omitted here.

In step S801, the determination unit 203 determines whether or not the value of the RSSI of the carrier sense is the first threshold value. If the value of the RSSI is not less than the first threshold value, the process proceeds to step S407. If the value of the RSSI is less than the first threshold value, the process proceeds to step S406.

In step S802, it is determined whether or not the variation of the RSSI of the received packet is the third threshold value. If the variation of the RSSI of the received packet is not less than the third threshold value, the process proceeds to step S407. If the variation of the RSSI of the received packet is less than the third threshold value, the process proceeds to step S410.

In the case where the state of the wireless device 101 is “fault”, the state will either remain “fault” or transition to “normal”. Since the transition from “fault” to “normal” requires certainty, the transition is executed when three determination conditions are satisfied, as illustrated in FIG. 8.

(1) State Transition from “Fault” to “Normal”

It is assumed that the RSSI of the received packet, which is obtained at time instant T1 in the process of step S401, is −65 [dBm], and the RSSI of the received packet obtained at time instant T2 is −64 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 8, in step S801, since the RSSI of the carrier sense result is −93 [dBm] and is less the first threshold value, the process proceeds to step S406. Subsequently, since the RSSI of the received packet is −64 [dBm] and is greater than the second threshold value, the process proceeds to step S802. Next, since the variation of the RSSI of the received packet is 1 [dB] that is the absolute value of the difference between −65 [dBm] and −64 [dBm], and is less than the third threshold value, a determination result that the state is “normal” is obtained.

Next, at time instant T3, it is assumed that the RSSI of the received packet is −63 [dBm], and the RSSI of the carrier sense result is −92 [dBm].

Like the above, to begin with, in step S801, since −92 [dBm], which is the RSSI of the carrier sense result, is less than the first threshold value, the process goes to step S406. Subsequently, since the RSSI of the received packet is −63 [dBm] and is greater than the second threshold value, the process proceeds to step S802. Next, since the variation of the RSSI of the received packet is 1 [dB] that is the absolute value of the difference between −64 [dBm] and −63 [dBm], and is less than the third threshold value, a determination result that the state is “normal” is obtained.

Subsequently, at time instant T4, it is assumed that the RSSI of the received packet is −64 [dBm], and the RSSI of the carrier sense result is −91 [dBm].

As above, in step S801, since −91 [dBm], which is the RSSI of the carrier sense result, is less than the first threshold value, the process goes to step S406. Subsequently, since the RSSI of the received packet is −64 [dBm] and is greater than the second threshold value, the process proceeds to step S802. Next, since the variation of the RSSI of the received packet is 1 [dB] that is the absolute value of the difference between −63 [dBm] and −64 [dBm], and is less than the third threshold value, a determination result that the state is “normal” is obtained.

In this case, since “normal” has been determined three consecutive times, the state of the wireless device 101 is transitioned from “fault” to “normal”, according to the state transition diagram illustrated in FIG. 3.

### Fourth Modification of the First Embodiment

In a fourth modification of the first embodiment, a description is given of the determination of the state transition in the case where the state of the wireless device 101 is “out-of-range”. The network configuration and the information stored at a time of wireless communication in the fourth modification, the fourth modification is the same as the first embodiment.

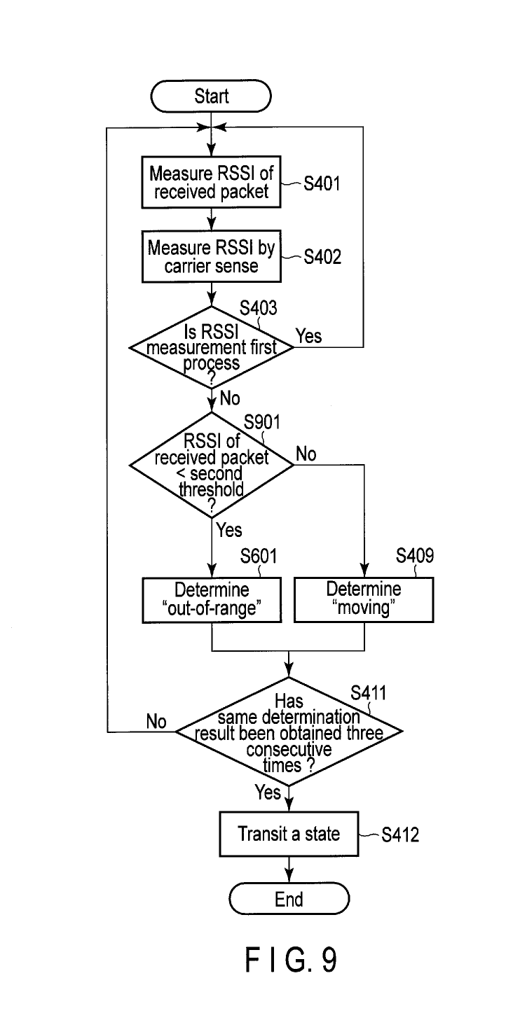

Referring to a flowchart of FIG. 9, the determination process of the monitoring apparatus 102 in the case where the current state of the wireless device 101 is “out-of-range” is described by illustrating a concrete example. Incidentally, since the steps excluding step S901 are the same as steps S401 to S403, step S409, step S411, step S412 and step S601, a description thereof is omitted here.

In step S901, the determination unit 203 determines whether or not the RSSI of the received packet is less than the second threshold value. If the RSSI of the received packet is less than the second threshold value, the process proceeds to step S601. If the RSSI of the received packet is not less than the second threshold value, the process proceeds to step S409.

At a time of “out-of-range”, the communication is disabled because of not a fault of the wireless device, but the movement of the wireless device. Thus, when the wireless device enters the range of communication from the “out-of-range” state, the wireless device necessarily transitions to the “moving” state. Thus, if the state of the wireless device is “out-of-range”, the state will either remain “out-of-range” or transition to “moving”.

At time instant T1, it is assumed that the RSSI of the received packet, which is obtained in the process of step S401, is −65 [dBm], and the RSSI of the received packet obtained at time instant T2 is −64 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 9, in step S901, since the RSSI of the received packet is −64 [dBm] and is greater than the second threshold value, the process proceeds to step S409, and a determination result that the state is “moving” is obtained.

Next, at time instant T3, it is assumed that the RSSI of the received packet is −63 [dBm], and the RSSI of the carrier sense result is −92 [dBm].

As above, in step S901, since the RSSI of the received packet is −63 [dBm] and is greater than the second threshold value, the process proceeds to step S409, and a determination result that the state is “moving” is obtained.

Subsequently, at time instant T4, it is assumed that the RSSI of the received packet is −64 [dBm], and the RSSI of the carrier sense result is −91 [dBm].

As above, in step S901, since the RSSI of the received packet is −64 [dBm] and is greater than the second threshold value, the process proceeds to step S409, and a determination result that the state is “moving” is obtained.

At time instant T4, since the same determination result has been obtained three consecutive times, the state of the wireless device 101 is transitioned from “out-of-range” to “moving”, according to the state transition diagram illustrated in FIG. 3.

According to the above-described first embodiment, the state is determined based on the RSSI of the signal that is transmitted from the wireless device and the state transition diagram, and thereby the three or more states of the wireless device can be determined without performing measurement in advance.

### Second Embodiment

In the first embodiment, the wireless device and the monitoring apparatus directly communicate, and the state determination of the wireless device is executed by measuring the RSSI at this time. A second embodiment differs from the first embodiment in that when wireless devices communicate with each other, the monitoring apparatus monitors packets between the wireless devices, thereby executing the state determination of the wireless devices. The network configuration and the information stored at a time of wireless communication in the second embodiment, the second embodiment is the same as the first embodiment.

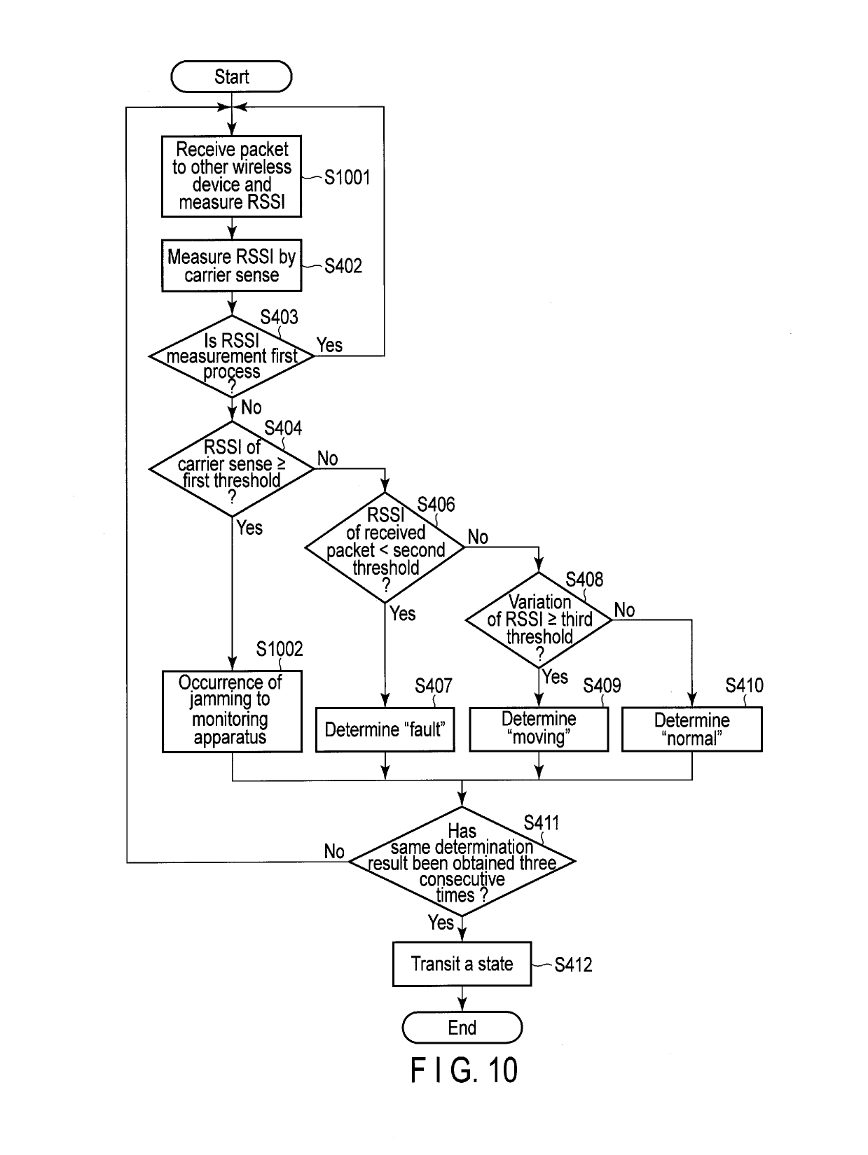

The determination process of the monitoring apparatus according to the second embodiment will now be described with reference to a flowchart of FIG. 10.

Since the same process as in the flowchart of FIG. 4 is executed except for step S1001 and step S1002, a description thereof is omitted.

In step S1001, when a certain wireless device A (first wireless device) has transmitted a packet including sense information to another wireless device B (second wireless device), the communication unit 201 of the monitoring apparatus 102 receives this packet addressed to the wireless device B, and measures the RSSI of the packet.

In step S1002, the determination unit 203 determines that a jamming exists in the communication between the monitoring apparatus 102 and the wireless device.

Next, a description is given of a concrete example of the determination process of the monitoring apparatus 102 according to the second embodiment.

At time instant T1, the RSSI of the received packet obtained in the process of step S1001, it is assumed that the RSSI of the packet from the wireless device A to wireless device B is −75 [dBm], and at time instant T2, the RSSI of the packet from the wireless device A to wireless device B is −74 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 10, in step S404, since the RSSI of the carrier sense result is −93 [dBm] and is less the first threshold value, the process proceeds to step S406. Next, since the RSSI of the packet to the wireless device B is −74 [dBm] and is greater than the second threshold value, the process proceeds to step S408. Subsequently, since the variation of the RSSI of the received packet from time instant T1 is 1 [dB] that is the absolute value of the difference between −75 [dBm] and −74 [dBm], and is less than the third threshold value, a determination result that the state of the wireless device A is “normal” is obtained.

Next, at time instant T3, it is assumed that the RSSI of the packet to the wireless device B is −73 [dBm], and the RSSI of the carrier sense result is −92 [dBm].

As above, in step S404, since −92 [dBm], which is the RSSI of the carrier sense result, is less than the first threshold value, the process proceeds to step S406. Next, since the RSSI of the packet to the wireless device B is −73 [dBm] and is greater than the second threshold value, the process proceeds to step S408. Subsequently, since the variation of the RSSI of the packet to the wireless device B is 1 [dB] that is the absolute value of the difference between −74 [dBm] and −73 [dBm], and is less than the third threshold value, a determination result that the state of the wireless device A is “normal” is obtained.

Subsequently, at time instant T4, it is assumed that the RSSI of the packet to the wireless device B is −74 [dBm], and the RSSI of the carrier sense result is −91 [dBm].

As above, in step S404, since −91 [dBm], which is the RSSI of the carrier sense result, is less than the first threshold value, the process proceeds to step S406. Next, since the RSSI of the packet to the wireless device B is −74 [dBm] and is greater than the second threshold value, the process proceeds to step S408. Subsequently, since the variation of the RSSI of the packet to the wireless device B is 1 [dB] that is the absolute value of the difference between −73 [dBm] and −74 [dBm], and is less than the third threshold value, a determination result that the state of the wireless device A is “normal” is obtained.

At time instant T4, since the same determination result has been obtained three consecutive times, the state of the wireless device A does not transition from “normal” to another state.

In this case, the monitoring apparatus 102 can determine the state of the wireless device A by receiving the packet including sensor information from the wireless device A to wireless device B and determining the state. In a case of such bidirectional communication that data is transmitted from the wireless device B to wireless device A, the state of the wireless device B can also be determined by the same process.

According to the above-described second embodiment, the monitoring apparatus monitors the communication between the wireless devices, and can determine the three or more states of the wireless device by using the temporal variation of the RSSI and the state transition diagram. In addition, the monitoring apparatus also monitors a packet which is transmitted from the wireless device A to a wireless device other than the wireless device B, for instance, a wireless device D, and executes the determination by the same procedure. Besides, determination results using packets transmitted from the wireless device A to other wireless devices may be combined, and the determination may be executed by majority decision. Thereby, the precision of the state determination of the wireless device A can be enhanced.

### Third Embodiment

In a third embodiment, when wireless devices communicate with each other, another wireless device monitors a communication packet between the wireless devices, and this another wireless device transmits a received result to the monitoring apparatus, thereby executing the state determination of the wireless device.

In this case, a wireless device A reads information from a sensor, and transmits a packet including sensor information to a wireless device B. When a wireless device C, which is a third wireless device, has received a communication packet from the wireless device A to the wireless device B, the wireless device C measures the RSSI of the received packet, and transmits the sensor information and the value of the RSSI to the monitoring apparatus.

As the second embodiment, the state determination process of the monitoring apparatus according to the third embodiment is described with reference to the flowchart of FIG. 10.

At time instant T1, the RSSI of the received packet obtained in the process of step S1001, it is assumed that the RSSI of the packet from the wireless device A to wireless device B is −70 [dBm], and at time instant T2, the RSSI of the packet from the wireless device A to wireless device B is −69 [dBm]. In addition, the RSSI of the carrier sense obtained in the process of step S402, it is assumed that the RSSI of the carrier sense at time instant T1 is −92 [dBm], and the RSSI of the carrier sense at time instant T2 is −93 [dBm].

In this case, the determination at time instant T2, according to the flowchart of FIG. 10, in step S404, since the RSSI of the carrier sense result is −93 [dBm] and is less the first threshold value, the process proceeds to step S406. Next, since the RSSI of the packet to the wireless device B is −69 [dBm] and is greater than the second threshold value, the process proceeds to step S408. Subsequently, since the variation of the RSSI of the received packet from time instant T1 is 1 [dB] that is the absolute value of the difference between −70 [dBm] and −69 [dBm], and is less than the third threshold value, a determination result that the state of the wireless device A is “normal” is obtained.

Next, at time instant T3, it is assumed that the RSSI of the packet to the wireless device B is −68 [dBm], and the RSSI of the carrier sense result is −92 [dBm].

As above, in step S404, since −92 [dBm], which is the RSSI of the carrier sense result, is less than the first threshold value, the process proceeds to step S406. Next, since the RSSI of the packet to the wireless device B is −68 [dBm] and is greater than the second threshold value, the process proceeds to step S408. Subsequently, since the variation of the RSSI of the packet to the wireless device B is 1 [dB] that is the absolute value of the difference between −69 [dBm] and −68 [dBm], and is less than the third threshold value, a determination result that the state of the wireless device A is “normal” is obtained.

Subsequently, at time instant T4, it is assumed that the RSSI of the packet to the wireless device B is −69 [dBm], and the RSSI of the carrier sense result is −91 [dBm].

Like the above, to begin with, in step S404, since −91 [dBm], which is the RSSI of the carrier sense result, is less than the first threshold value, the process goes to step S406. Next, since the RSSI of the packet to the wireless device B is −69 [dBm] and is greater than the second threshold value, the process proceeds to step S408. Subsequently, since the variation of the RSSI of the packet to the wireless device B is 1 [dB] that is the absolute value of the difference between −68 [dBm] and −69 [dBm], and is less than the third threshold value, a determination result that the state of the wireless device A is “normal” is obtained.

At time instant T4, since the same determination result has been obtained three consecutive times, the state of the wireless device A does not transition from “normal” to another state.

In the meantime, in a case of such a mode that information is transmitted to the monitoring apparatus by aggregating data of wireless devices, like a mesh-network or multi-hop communication, values of RSSIs of other wireless devices can be collected by combining the case of direct communication with the monitoring apparatus as in the first embodiment with the third embodiment. Thus, the state transition of wireless devices in the environment can be understood.

According to the above-described third embodiment, a third wireless device monitors the communication between wireless devices and transfers the monitored information to the monitoring apparatus, and the three or more kinds of states of the wireless device can be determined by using the temporal variation of the RSSI and the state transition diagram. In addition, the wireless device C also monitors a packet which is transmitted from the wireless device A to a wireless device other than the wireless device B, and executes notification to the monitoring apparatus. By the same procedure, the monitoring apparatus executes the determination. By executing the determination by majority decision, based on determination results using packets transmitted from the wireless device A to plural wireless devices other than the wireless device B, the precision of the state determination of the wireless device A can be enhanced. Furthermore, a wireless device other than the wireless device C monitors packets which are transmitted from the wireless device A, executes notification to the monitoring apparatus, and then the determination may be executed by the same procedure. The monitoring apparatus executes the determination by majority decision, based on the information obtained from plural wireless devices by using packets transmitted from the wireless device A to the plural wireless devices, and thereby the precision of the state determination of the wireless device A can be enhanced.

### Fourth Embodiment

A fourth embodiment differs from the above-described embodiments in that the transition of the state is notified to the outside.

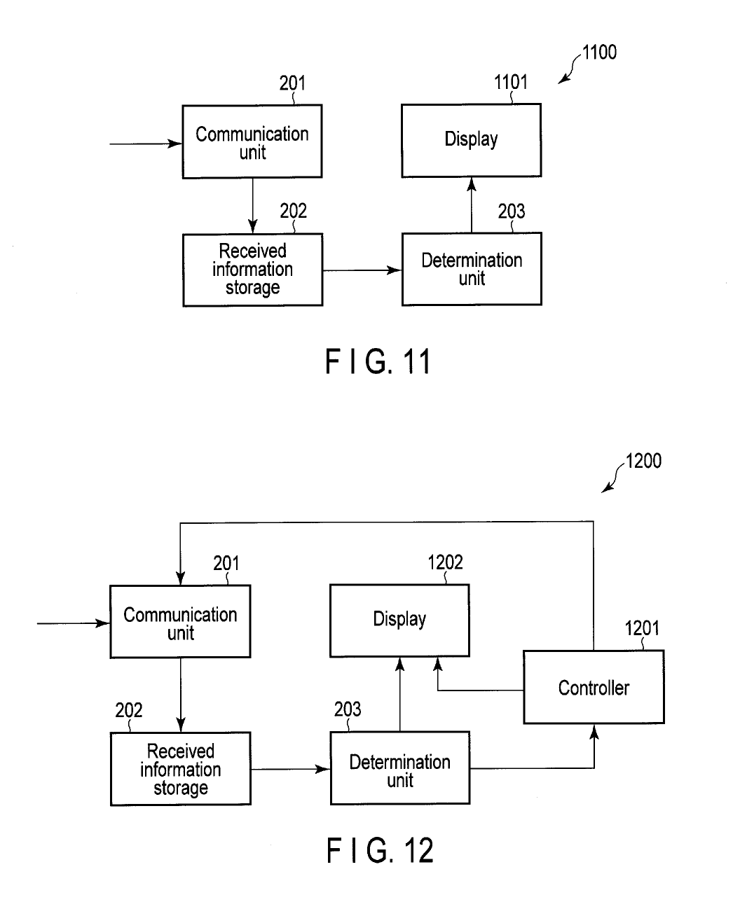

A monitoring apparatus according to the fourth embodiment is described with reference to a block diagram of FIG. 11.

A monitoring apparatus 1100 according to the fourth embodiment includes a communication unit 201, a received information storage 202, a determination unit 203 and a display 1101. Since the communication unit 201, received information storage 202 and determination unit 203 execute the same operations as in the first embodiment, a description thereof is omitted here.

The display 1101 is, for example, a screen. The display 1101 receives the state of the wireless device 101 from the determination unit 203, and displays a text, such as “normal” or “fault”, in accordance with the state of the wireless device 101. In addition, display may be displayed such that the state of the wireless device 101 can be distinguished by a color in accordance with the state of the wireless device 101. For example, display may be displayed in blue when the state is “normal”, or in red when the state is “fault”. Besides, a light-emitting diode (LED) may be lighted or flickered, or the intervals of flickering may be varied in accordance with the state of the wireless device.

According to the above-described fourth embodiment, the user can easily understand the state of each wireless device.

### Fifth Embodiment

In the case where a faulty wireless device exists when wireless devices 101 communicate with each other, an area in which wireless communication is disabled will occur in the vicinity of the faulty wireless device. Thus, a fifth embodiment differs from the above-described embodiments in that, in accordance with the state of the wireless device, in order to reduce the influence of the coverage area in which wireless communication is disabled, the control of the wireless device is executed, or notification to other devices is executed.

A monitoring apparatus according to the fifth embodiment is described with reference to a block diagram of FIG. 12.

A monitoring apparatus 1200 according to the fifth embodiment includes a communication unit 201, a received information storage 202, a determination unit 203, a controller 1201, and a display 1202. Since the communication unit 201, received information storage 202 and determination unit 203 execute the same operations as in the fourth embodiment, a description thereof is omitted here.

The controller 1201 receives from the determination unit 201 transmission source information relating to the wireless device 101, the state of which has been determined to be “fault”, and executes such control that another wireless device 101 existing around the wireless device 101, which has been determined to be “fault”, increases a transmission output, thereby to cover the area of the wireless device 101 which has been determined to be “fault”. Specifically, for example, the communication unit 201 is notified of control information including an instruction to increase the output of the other wireless device 101 existing nearby, and a control signal may transmitted from the communication unit 201 to the other device 101.

In addition, if it has been determined that a jamming occurs to the wireless device 101, the controller 1201 may execute control to increase the output of the wireless device 101 so that the transmission output becomes stronger than the radio wave that becomes the jamming. Besides, if a usable frequency channel, other than the radio wave that becomes the jamming, exists, the controller 1201 may execute control such that communication is executed by using the other frequency channel.

The display 1202 is substantially the same as the display 1101 relating to the fourth embodiment. However, the display 1202 further receives information relating to the control from the controller 1201, and displays the information relating to the control. Specifically, for example, if the content of the control in the controller 1201 is an increase of the transmission output, the display 1201 may display a text such as “increase of output”.

According to the above-described fifth embodiment, the transmission output is controlled in accordance with the determined state of the wireless device, and thereby the drawback of the system can be compensated, and the normal state can be maintained.

The flowcharts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A monitoring apparatus, comprising:
a communication unit configured to calculate a first indicator value and a second indicator value, the first indicator value relating to a received signal strength at a time when a packet transmitted from a first wireless device is received, the second indicator value relating to a received signal strength at a time when carrier sense is executed; and
a determination unit configured to determine a new state of the first wireless device to be one of three or more states, by performing a state determination using the first indicator value and the second indicator value, with a current state of the first wireless device being set as a basic point.

2. The apparatus according to claim 1, wherein the communication unit sets the first indicator value to a value relating to a received signal strength not more than a limit value of receiving, if the packet from the first wireless device is unable to receive.

3. The apparatus according to claim 1, further comprising a display configured to display the state of the first wireless device using at least one of a text and a color.

4. The apparatus according to claim 1, wherein the first indicator value is a difference value between a first received signal strength at a time when a packet transmitted from the first wireless device is received, and a second received signal strength measured immediately prior to the first received signal strength.

5. The apparatus according to claim 1, wherein the first indicator value is a level value classified based on a magnitude of the received signal strength.

6. The apparatus according to claim 1, wherein the states include a jamming which is a state that a jamming occurs in communication of the first wireless device, a fault which is a state that the first wireless device is faulty, a moving which is a state that the first wireless device is moving, an out-of-range which is a state that the first wireless device exists at a location where the first wireless device is unable to communicate, and a normal which is a state that the first wireless device is normally operating.

7. The apparatus according to claim 6, wherein the determination unit determines the state to be the fault, if the second indicator value is less than a first threshold value and the first indicator value is less than a second threshold value, in a case where the current state of the first wireless device is the normal, and determines the state of the first wireless device to be the out-of-range, if the second indicator value is less than the first threshold value and the first indicator value is less than the second threshold value, in a case where the current state of the first wireless device is the moving.

8. The apparatus according to claim 6, wherein the determination unit determines the state to be the jamming, if the second indicator value is not less than the first threshold value.

9. The apparatus according to claim 6, wherein the determination unit determines the state to be the moving, if the second indicator value is less than the first threshold value, the first indicator value is not less than the second threshold value, and an absolute value of a difference between the first indicator value and a third indicator value is not less than a third threshold value, the third indicator value relating to a received signal strength measured immediately prior to the first indicator value.

10. The apparatus according to claim 6, further comprising a controller configured to execute control such that a second wireless device increases a transmission output, if the state is the fault, and to execute control such that the first wireless device increases a transmission output, if the state is the jamming.

11. A monitoring method, comprising:
calculating a first indicator value and a second indicator value, the first indicator value relating to a received signal strength at a time when a packet transmitted from a first wireless device is received, the second indicator value relating to a received signal strength at a time when carrier sense is executed; and
determining a state of the first wireless device to be one of three or more states, by performing a state determination using the first indicator value and the second indicator value, with a current state of the first wireless device being set as a basic point.

12. The method according to claim 11, wherein the calculating the first indicator value sets the first indicator value to a value relating to a received signal strength not more than a limit value of receiving, if the packet from the first wireless device is unable to receive.

13. The method according to claim 11, further comprising displaying the state of the first wireless device using at least one of a text and a color.

14. The method according to claim 11, wherein the first indicator value is a difference value between a first received signal strength at a time when a packet transmitted from the first wireless device is received, and a second received signal strength measured immediately prior to the first received signal strength.

15. The method according to claim 11, wherein the first indicator value is a level value classified based on a magnitude of the received signal strength.

16. The method according to claim 11, wherein the states include a jamming which is a state that a jamming occurs in communication of the first wireless device, a fault which is a state that the first wireless device is faulty, a moving which is a state that the first wireless device is moving, an out-of-range which is a state that the first wireless device exists at a location where the first wireless device is unable to communicate, and a normal which is a state that the first wireless device is normally operating.

17. The method according to claim 16, wherein the determining the state determines the state to be the fault, if the second indicator value is less than a first threshold value and the first indicator value is less than a second threshold value, in a case where the current state of the first wireless device is the normal, and determines the state of the first wireless device to be the out-of-range, if the second indicator value is less than the first threshold value and the first indicator value is less than the second threshold value, in a case where the current state of the first wireless device is the moving.

18. The method according to claim 16, wherein the determining the state determines the state to be the jamming, if the second indicator value is not less than the first threshold value.

19. The method according to claim 16, wherein the determining the state determines the state to be the moving, if the second indicator value is less than the first threshold value, the first indicator value is not less than the second threshold value, and an absolute value of a difference value between the first indicator value and a third indicator value is not less than a third threshold value, the third indicator value relating to a received signal strength measured immediately prior to the first indicator value.

20. The method according to claim 16, further comprising executing control such that a second wireless device increases a transmission output, if the state is the fault, and control such that the first wireless device increases a transmission output, if the state is the jamming.
